(19) United States
(12) Patent Application Publication
(10) Pub. No.: US 2007/0085883 A1
(43) Pub. Date: Apr. 19, 2007

(54) Inkjet Cartridge Maintenance and Refill Device and Method

(76) Inventor: Harry E. Nicodem, Richmond, IL (US)

Correspondence Address: VEDDER PRICE KAUFMAN & KAMMHOLZ, 222 N. LASALLE STREET, CHICAGO, IL, 60601, US

(21) Appl. No.: 11/379,717

(22) Filed: Apr. 21, 2006

Related U.S. Application Data
(60) Provisional application No. 60/673,513, filed on Apr. 21, 2005.
(60) Provisional application No. 60/711,058, filed on Aug. 24, 2005.

(51) Int. Cl. B41J 2/175

(52) U.S. Cl. 347/86; 347/85

(57) ABSTRACT

The present disclosure relates to a black and color inkjet cartridge testing and refilling device and method of use thereof. The device includes a testing station and a refilling station to be used in conjunction with a user-friendly interface able to guide a user through the steps associated with refilling an inkjet cartridge. The device is able to store waste ink, contain an significant supply of refill ink, and even house stickers and clips to be placed on refilled cartridges to prevent drying. The device is able to guide a user through an initial determination of the capacity to refill the type of cartridge desired. The automated control system also helps users through easy cleaning procedures, test printing procedures, and purge operations.

### CROSS-REFERENCE TO RELATED APPLICATION

The present patent application claims the benefit of U.S. Provisional Patent Application No. 60/673,513, filed on Apr. 21, 2005, and entitled INKJET CARTRIDGE TESTER, which prior application is hereby incorporated by reference, U.S. Provisional Patent Application No. 60/711,058, filed on Aug. 24, 2005, and also claims the benefits, where applicable, of U.S. patent application Ser. No. 11/373,026, filed on Mar. 10, 2005, and entitled METHOD AND APPARATUS FOR A PRINTER CARTRIDGE TESTER, with the same effect as though the prior application were fully and completely set forth herein.

### FIELD OF THE DISCLOSURE

The present disclosure generally relates to a device and method for refilling inkjet cartridges, and more particularly, to an improved diagnostic, maintenance, testing, and refilling device and method of use thereof.

### BACKGROUND

Ink jet printers use inkjet cartridges to place ink on paper scrolling under a movable printing head. Ink jet cartridges contain a fixed quantity of ink and are generally discarded once the ink supply has run out. Ink jet cartridges are equipped with a head with nozzles that contact with the printing head on the printer to release ink at appropriate locations in sufficient quantities. If a large quantity of ink is placed in the reservoir of the cartridge, the head member on the printer becomes difficult to move due to weight. Ink jet printers are often compact and need a rapidly moving printing head to print pages rapidly. As a result of this fundamental limitation, the ink reservoir must be minimal in size and is therefore depleted long before any significant damage or wear to a cartridge shell is encountered. A cartridge depleted of ink may often be made whole if the ink supply is replenished. Constant refilling of the same cartridge ultimately damages the cartridge shell and its ink releasing nozzles.

Financial and environmental constraints often motivate users of ink jet printers to refill depleted yet fully operational cartridges if this operation is not too troublesome. Certain type of cartridges may prove to be more costly to replace than buying bulk volumes of refill ink, and due to a wide variety of inkjet cartridges on the market, the management of stock based on the availability from a local supplier may be troublesome.

One of the disadvantage of prior art inkjet refilling machines is their complexity of operation and the incapacity to service and refill many different types and sizes of cartridges while retaining simplicity of operation. As a result of procedural steps these machines require, users may end up in physical contact with ink. In addition, prior art devices are unable to offer a flexible and user-friendly multistep diagnostic method able to guide a user through a plurality of maintenance steps including cleaning, nozzle test and diagnostic, printing tests, drainage, and purges of residual ink able to not only refill a cartridge a first time but to ensure that the cartridge shell and nozzles are still adequately operational after multiple refills.

Manual refill kits for printer cartridges are available in the market. However, these manual refill kits come with too many parts and require lengthy procedures to be followed by users in order to effect the refill. In addition, the risk of physical contact with the ink is substantial. Accordingly, it is desirable to provide a device that is capable of refilling a wide variety of printer cartridges while maintaining a high level of control over cartridge shell integrity. The device must also include a user-friendly interface and manage supplies such as waste ink, refill ink, clips, and new labels while being equipped with state of the art diagnostic and maintenance set of procedures to reuse as many cartridges as possible.

### SUMMARY

The present disclosure relates to a black and color inkjet cartridge testing and refilling device and method of use thereof. The device includes a testing station and a refill station to be used in conjunction with a user-friendly interface able to guide a user during the steps associated with refilling an inkjet cartridge. The device is able to store waste ink, contain an substantial supply of refill ink, and even house stickers and clips to be placed on refilled cartridges to prevent drying. The device is also designed to guide a user through an initial determination of the capacity to refill the type of cartridge desired. The automated control system also helps users through easy cleaning procedures, test printing procedures, and purge operations.

The invention disclosed in a first embodiment is a refilling station equipped with a lower and an upper cabinet. A user is instructed to insert a cartridge on the appropriate testing station and refilling station using either a touch-screen display or light-emitting diodes. The automated control system determines what modules must be used and evaluates the integrity of the cartridge at each step of the step-by-step user guiding process.

### BRIEF DESCRIPTION OF THE DRAWINGS

FIG. 1 is a perspective 3D view of an inkjet cartridge maintenance and refill device constructed in accordance with the teachings of the present disclosure.

FIG. 2 is a front view of the device of FIG. 1 illustrating the components on the upper and lower cabinets.

FIG. 3 is a perspective 3D view of the lower cabinet of the device of FIG. 1.

FIG. 4 is a front view of a storage cabinet of the device of FIG. 1 without the front doors.

FIG. 5 is a flow chart illustrating the method for testing and refilling an inkjet cartridge using the device of FIG. 1.

FIG. 6 is a flow chart illustrating additional steps of a second embodiment of the method for testing and refilling an inkjet cartridge using the device of FIG. 1.

FIG. 7 is a flow chart illustrating the method for testing and refilling a color inkjet cartridge using the device of FIG. 1.

FIG. 8 is a flow chart illustrating additional steps of a second embodiment of the method for testing and refilling a color inkjet cartridge using the device of FIG. 1.

FIG. 9 is a top view of the ink storage drawer.

FIG. 10 is a series of three 3D views of a sample type and size inkjet cartridge to be used in conjunction with the device of FIG. 1.

FIG. 11 is a block diagram of the automated computer system of the device shown in FIG. 1.

### DETAILED DESCRIPTION

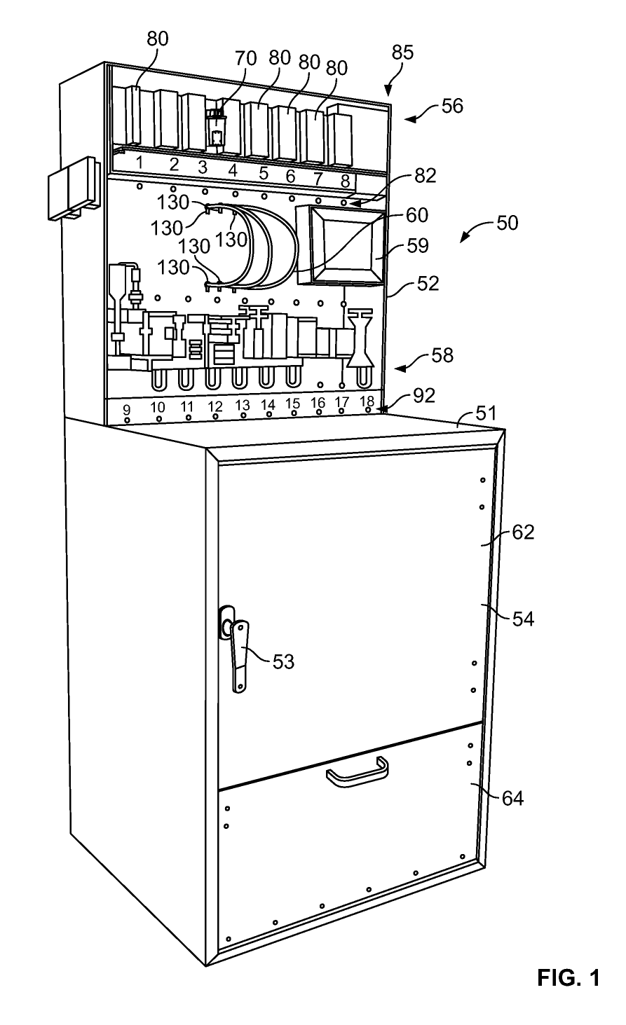

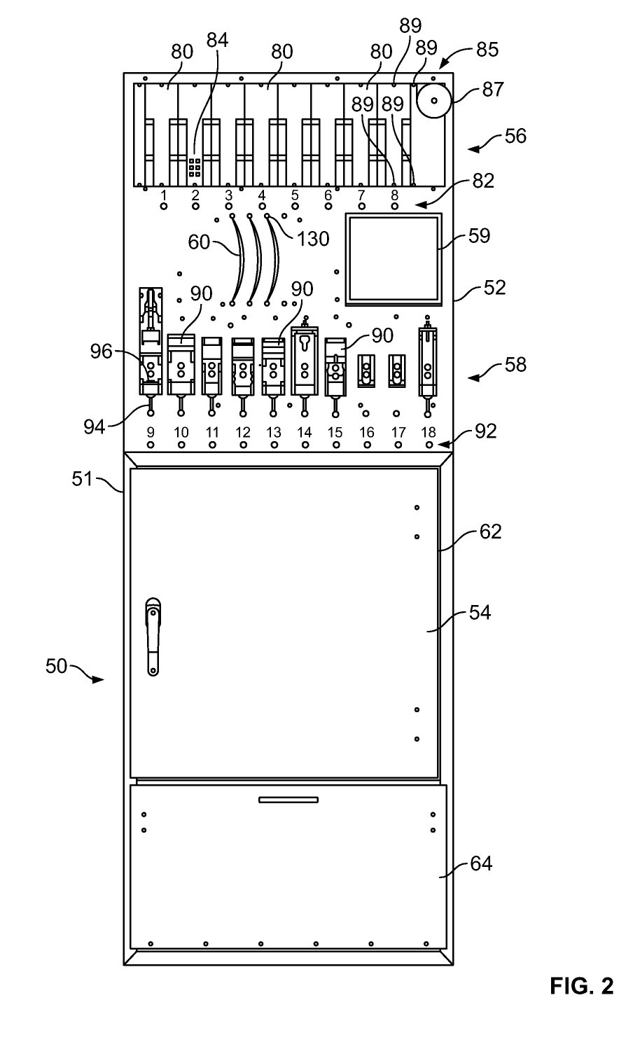

Referring to FIGS. 1 and 2, an inkjet cartridge maintenance and refill device 50 constructed in accordance with the teachings of the present disclosure is shown. FIG. 1 shows device 50 including a housing 51 made of an upper cabinet 52 and a lower cabinet 54. The upper cabinet 52 may house electronic and mechanical components necessary for operation of the device 50, while the lower cabinet 54 supports the upper cabinet 52 and may also provide storage for accessories, storage ink, and parts that may be needed prior to and after maintenance and refilling of inkjet cartridges. In addition, the lower cabinet 54 may house ink supply containers 55 as described in further detail below.

The upper cabinet 52 includes a testing station 56 located on the upper portion thereof and a filling station 58 located on the lower front portion thereof. Between the testing station 56 and the filling station 58, the upper cabinet 52 includes a touch-screen monitor used as an interface 59 to provide interactive operation of the device 50 by a user. Additionally, the upper cabinet 52 includes the plurality of color fill needles 60, the functions of which are described below.

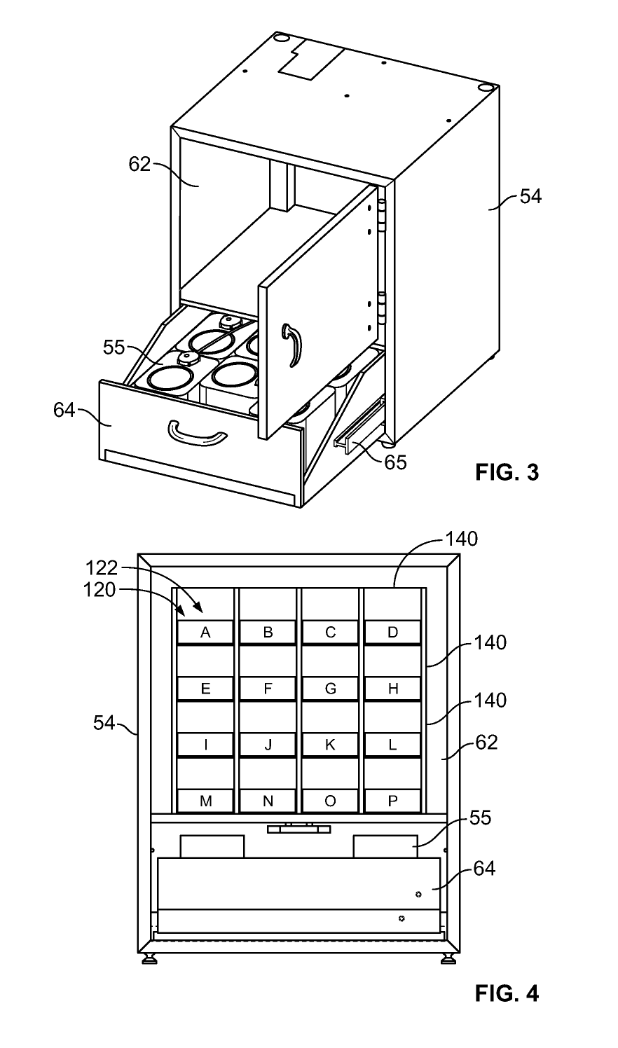

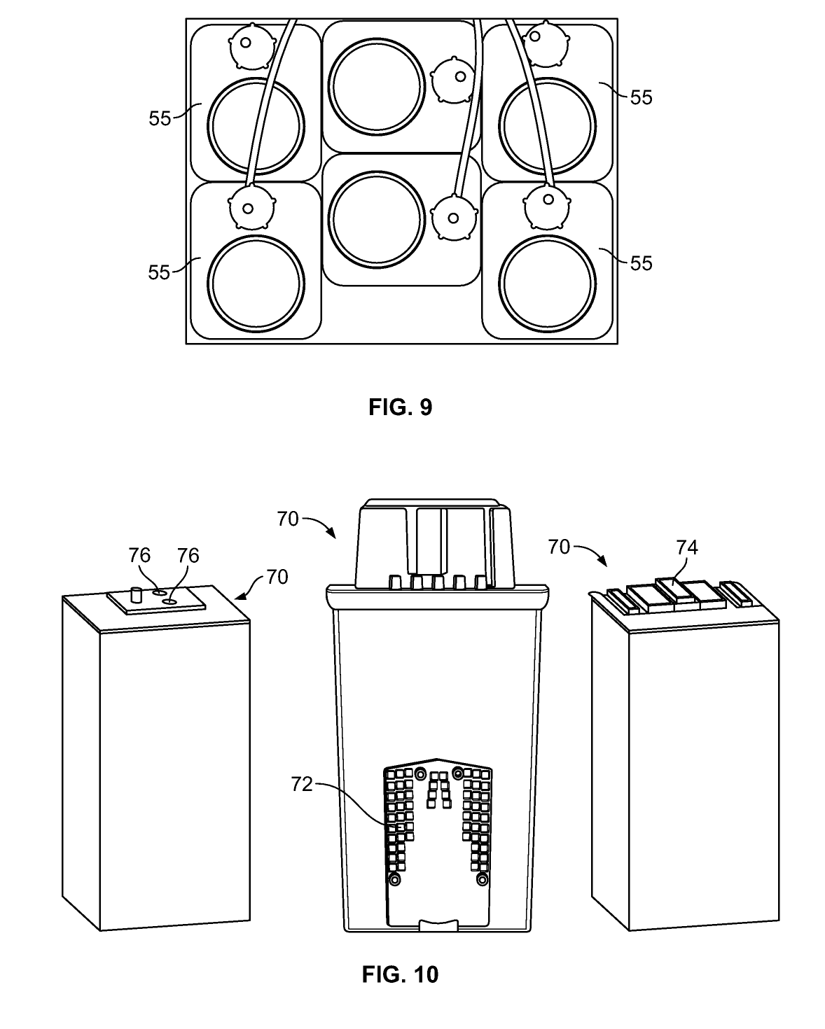

The lower cabinet 54 includes an equipment storage cabinet 62, a portion of which may be hinged on one side so as to open and close to allow an operator access to the contents thereof. The lower cabinet 54 also includes a drawer 64 that can be pulled out by a user to access the contents thereof. The drawer 64 is configured to hold the ink supply containers 55 as shown in FIGS. 3, 4, and 9. The ink supply containers 55 in a preferred embodiment may have two containers of black ink, one container having waste ink, and three more containers having color ink in the colors cyan, yellow, and magenta. It is understood by one of ordinary skill in the art that while one combination of ink colors is disclosed, a multitude of possible arrangements is conceivable based on actual client demand, the volume of waste ink, the size of the cartridges to be filled, and the like. Because the ink supply containers 55 may be heavy, a user can simply pull out the drawer 64, lift the ink supply containers 55 out of the drawer, or place ink supply containers 55 in the drawer 64 when necessary. The drawer 64 may be supported by a pair of opposing telescopic drawer slides 65 that allow the drawer 64 to be pulled out fully from the cabinet 54 so that the user can simply have access to each of the ink supply containers 55 or containers stored in the drawer 64 without having to reach inside the drawer 64.

It is understood by one of ordinary skill in the art that while a lower cabinet 54 with one drawer 64 and one equipment storage cabinet 62 is shown, a plurality of possible storage configurations including a lower cabinet with four different drawers and a pull shelf or any other possible configuration where ink supply containers 55 may be stored is contemplated. The lower cabinet 54 may also be equipped with one or a plurality of locking mechanisms 53 to limit access to the interiors of the compartments of the lower cabinet 54 and help with the opening of the lower cabinet 54.

Referring to FIG. 10, a typical inkjet cartridge 70 is shown. One of ordinary skill in the art will readily appreciate that inkjet cartridges may differ significantly in configuration and operation depending on the manufacturer of the inkjet cartridge. However, inkjet cartridges typically include certain essential components described herein. The inkjet cartridge 70 includes a plurality of electrical contacts 72 that can be used to control the nozzles 74 of the cartridge 70. On top of the inkjet cartridge 70, a plurality of vent holes 76 equalize the pressure inside the inkjet cartridge 70 with the outside pressure when ink is being dispensed from the nozzles 74. The essential components of a color cartridge are the same as the components of a black inkjet cartridge.

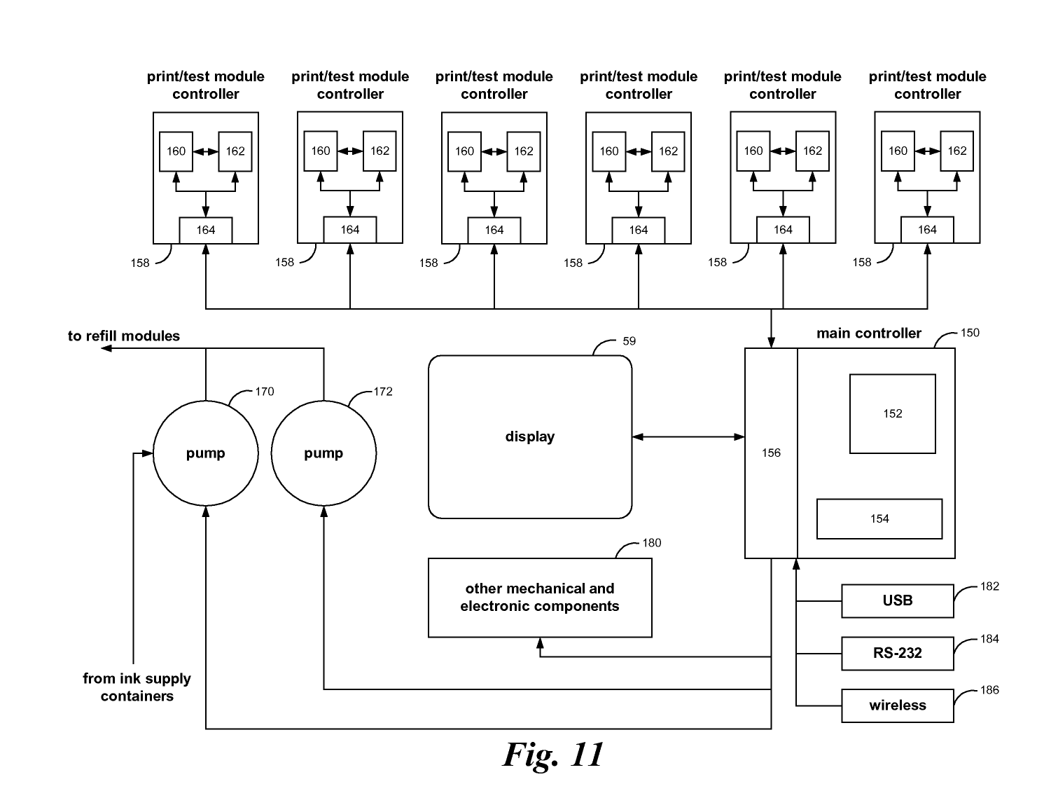

The inkjet cartridge testing and refilling device as shown in FIG. 1 comprises a housing 51 a cartridge testing station 56, a refilling station 58, an ink supply 55, an automated control system shown as FIG. 11, and a display interface 59 made of a touch-screen monitor. In one embodiment, the cartridge testing station 56, the cartridge refilling station 58 and the display interface 59 are mounted in the housing 51, the ink supply 55 is connected to the cartridge refilling station 58 by an ink pumping and transporting means 170, 172 as shown on FIG. 11, and the automated control system of FIG. 11 is located inside of the housing 51 and is connected via a series of electronic controls to the refilling station 58, the testing station, the ink pumping and transporting means, and the display interface 59.

The operation of the device 50, and the use of the testing station 56 and the refilling station 58 is described below in detail as to how they relate to the graphical display interface 59 provided by the touch-screen monitor to provide step-by-step operation of the device 50. Each display screen of the display interface 59 may include navigation buttons that enable the user to, for example, go back a step, go forward a step, abort, or request more information as the user progresses through the cycle of steps for using the device 50. A user can touch the display interface 59 at any location to activate the monitor.

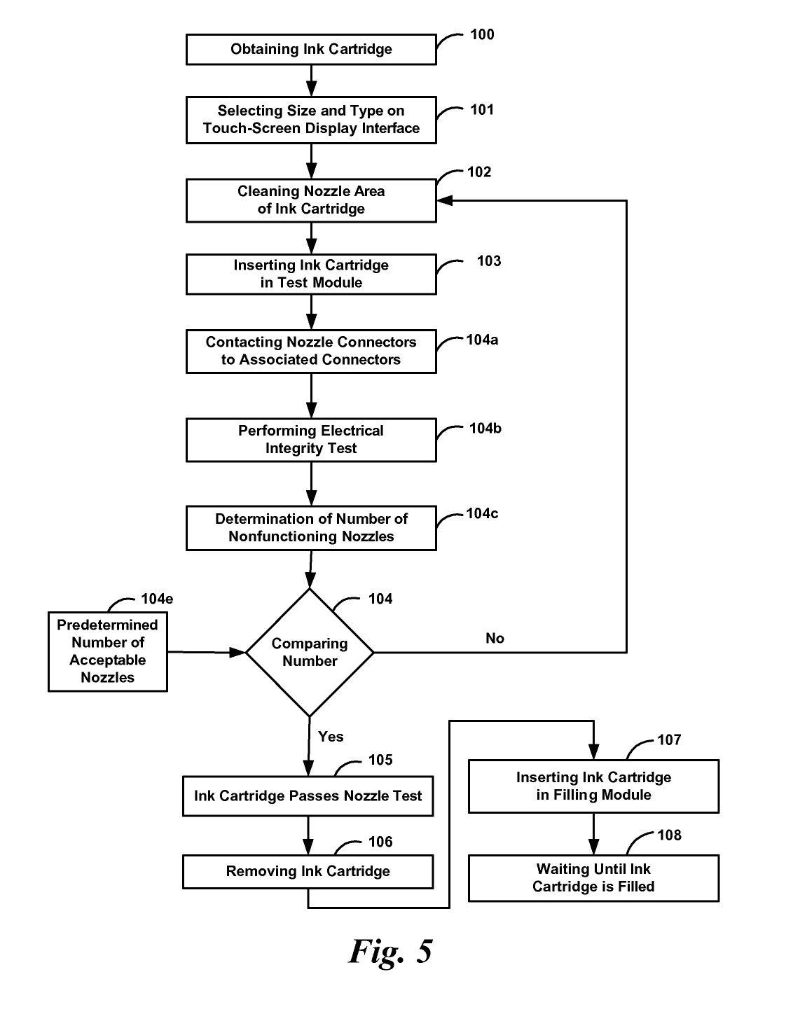

In one preferred embodiment, with steps shown in FIG. 5, the user first obtains an inkjet cartridge 70 to be refilled 100. The display interface 59 displays a list of various manufacturers of inkjet cartridges from which the user can, in a first step, select the manufacturer of the particular inkjet cartridge 70 for which refilling or maintenance is needed. After selecting 101 the manufacturer of the inkjet cartridge 70, the various models of the inkjet cartridges manufactured by that manufacturer are displayed. The user is then instructed once a specific model of inkjet cartridge is selected to manually clean the nozzles 74 of the inkjet cartridge 70. In one preferred embodiment, the user is directed to use a cleaning pad located conveniently either on or inside of the housing 51.

The user is next instructed by a signal associated with one of the test modules 80 of the testing station 56 to insert the inkjet cartridge 70 in the selected print/test module 80 by the automated control system as shown on FIG. 11 using the display interface 59. The testing station 56 includes a plurality of print/test modules 80, each of which is configured for a particular type of inkjet cartridge 70. In a preferred embodiment shown in FIG. 1, each print/test module 80 is designated with a particular number and a display such as a Light Emitting Diode (LED) 82, shown below the corresponding print/test module 80. When the user is instructed to insert 103 the inkjet cartridge 70 in the print/test module 80 as shown on FIG. 5, the user is also informed which print/test module 80 to use either by an illustration on the graphical display interface 59, a number, or a lit LED 82. For example, the display on the monitor 59 may instruct a user to place the inkjet cartridge 70 in the print/test module number 3 as shown on FIG. 1. The LED 82 below the print/test module 80 that is to be used may illuminate to guide the user to the correct print/test module 80 to use for the particular inkjet cartridge 70 that is to be maintained and refilled by the user.

Each print/test module 80 includes a plurality of electrical contacts 84 that are configured to correspond with the electrical contacts 72 associated with a particular inkjet cartridge 70. Therefore, when an inkjet cartridge 70 is inserted in the proper print/test module 80, the contacts 84 of the module and the contacts 72 of the inkjet cartridge 70 connect 104a. Upon connection of the contacts 72 and 84, the device 50 performs a cartridge electrical test to determine the electrical integrity 104b of the circuitry that operates the nozzles 74 of the inkjet cartridge 70. Each nozzle 74 may include one or more transistors (not shown) that, if the transistor fails to open and close, may cause malfunction in the nozzle 74. Therefore, during the electrical test in the print/test module 80, the device 50 may test each transistor for electrical integrity.

The display interface 59 may provide the user with the number of open transistors and the number of closed transistors in the cartridge 70 upon the completion of the electrical tests 104c. If the number of short transistors exceeds a certain predetermined number 104e, the electrical test may fail and the user is instructed to take the cartridge 70 out of the print/test module 80, clean the contact area 102 again, and conduct the electrical test again 104 to 104e. Similarly, during the electrical test of the cartridge 70, the number of shorts that may be discovered may be above a predetermined 104e acceptable number by the automated control system as shown as FIG. 11. If so, the electrical test may fail and the user is instructed on the screen to repeat the process after recleaning the contact area 102 and performing the electrical test again. Should the inkjet cartridge 70 fail the electrical test repeatedly, the user is given a message on the display interface 59 that the inkjet cartridge 70 failed the electrical test and may not be maintainable or refillable.

If the inkjet cartridge 70 passes the electrical test 105, or if it is determined, for example, that a sufficient quantity of nozzles are functioning properly 104, a message indicating such a result is provided to the user on the touch-screen and the user is prompted to continue to the next step in the process of maintenance and refilling of the cartridge 70. The user is then instructed via the display interface 59 to remove the cartridge 106 from the print/test module 80 and insert it 107 in a proper refilling module 90 of the filling station 58. Each refilling module 90 includes a number to guide the user regarding the correct refilling module 90 in which to insert the inkjet cartridge 70. Additionally, each refilling module 90 is associated with an LED 92 disposed next to the refilling module 90, which is activated after the electrical test so that the user knows the correct refilling module 90 in which to insert the cartridge 70 to continue the maintenance and refill operation.

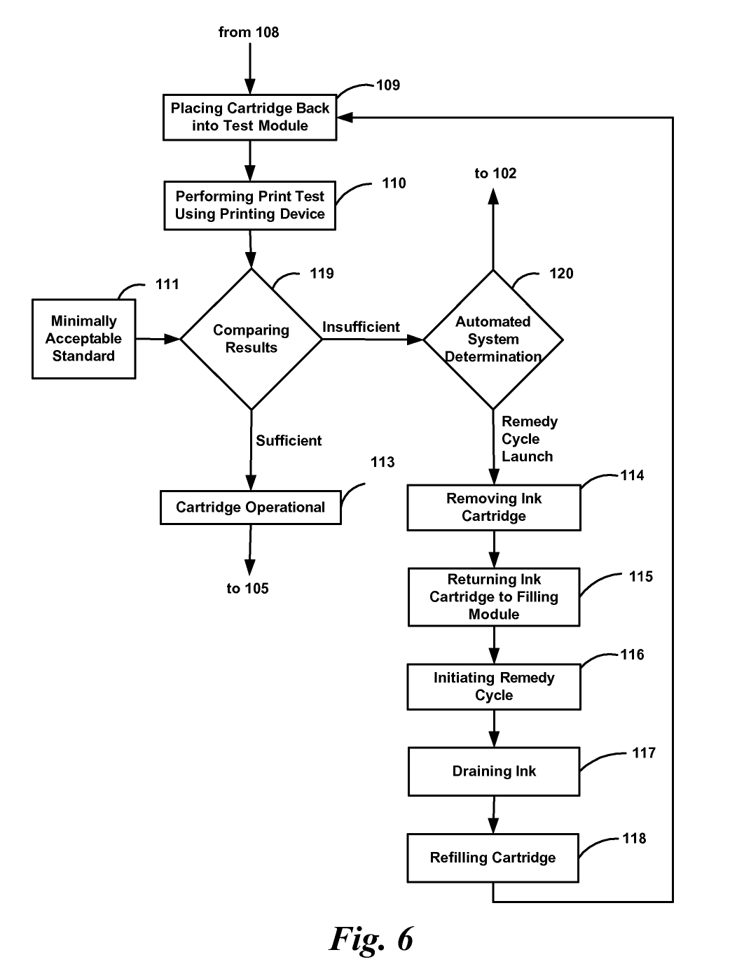

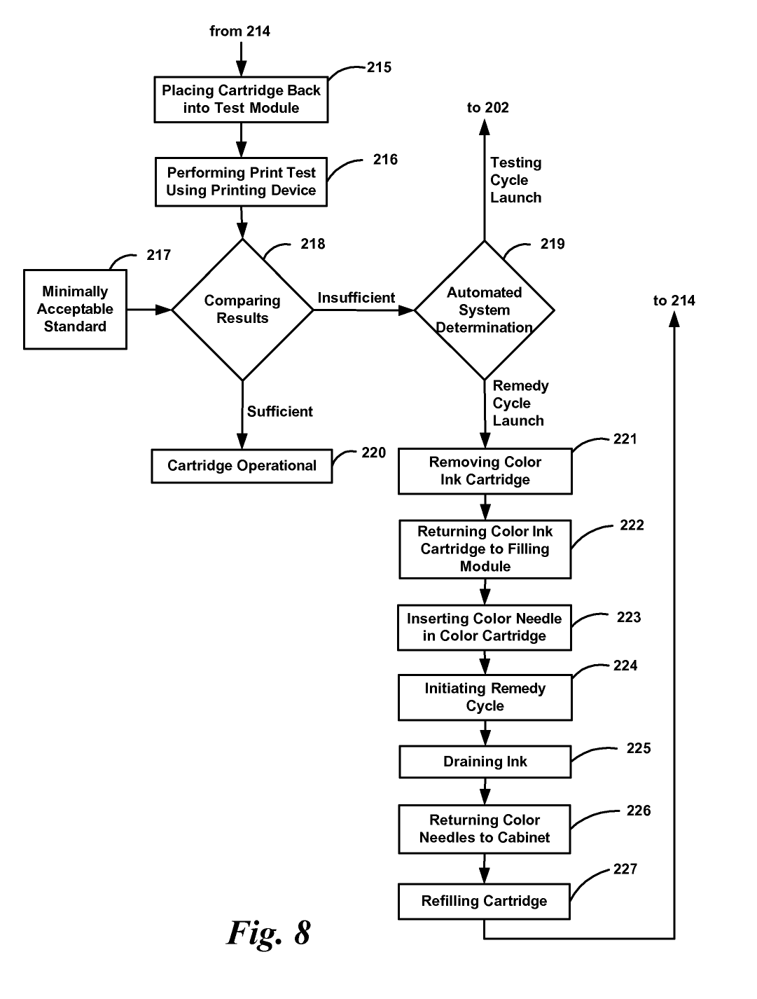

When the user inserts the inkjet cartridge 70 in the corresponding refilling module 90, depending on whether the inkjet cartridge 70 is a black inkjet cartridge 70 or a color cartridge 70, the procedure for maintaining and refilling the cartridge 70 may be different. The procedure for refilling a black inkjet cartridge 70 is described first. The procedure for refilling a color cartridge 70 is described second. The steps relating to refilling a black inkjet cartridges are shown on FIG. 6 and the steps relating to refilling the color inkjet cartridge are shown on FIG. 8.

The bottom of each refilling module 90 includes a black ink refilling interface 94 as shown on FIG. 2 and a seal 96 disposed on top thereof. When the inkjet cartridge 70 is inserted in the corresponding refilling module 90, the bottom of the cartridge where the nozzles 74 as shown on FIG. 10 are disposed presses on the seal 96 located over the black ink refilling interface 94. Accordingly, the black ink refilling interface 94 and the nozzles 74 of the inkjet cartridge 70 can be fluidically coupled so that black ink can be transferred from the black ink refilling interface 74 to the black inkjet cartridge 70 through the nozzles without any black ink leaking at the seal 96. If the black inkjet cartridge 70 is improperly seated in the refilling module 90, the display interface 59 instructs the user to remove the inkjet cartridge 70 and replace the inkjet cartridge 70 in the corresponding refilling module 90 to continue the process. Once the black inkjet cartridge 70 is properly placed in the corresponding refilling module 90, the device 50 can evacuate all of the black ink that may be in the black inkjet cartridge prior to refilling the black inkjet cartridge with fresh black ink.

The device 50 then proceeds, based on instructions from the automated control system shown as FIG. 11, to evacuate residual ink from the inkjet cartridge 70. A display may be shown on the interface display 59 to the user that illustrates the progress of the evacuation of the residual ink from the inkjet cartridge 70. In a preferred embodiment, the display interface 59 includes a vacuum meter that shows the vacuum level in terms of inches of mercury (in Hg) and an ink pressure meter that shows ink pressure in pounds per square inch (psi). The display interface 59 may also show the level of ink in the cartridge 70 so that a user can see the progress of the current operation.

After the residual ink is evacuated from the inkjet cartridge 70, the automated control system shown as FIG. 11 fills the cartridge with fresh ink. In a preferred embodiment, the display interface 59 displays the progress of the filling operation of the cartridge 70 with the help of a vacuum meter or a pressure meter. Once refilling is finished 108, the device 50 instructs the user to remove the inkjet cartridge 70 from the filling module 90 and use a cleaning pad to wipe the ink off the nozzle 74.

The user is then instructed to place 109 the inkjet cartridge 70 in the print/test module 80. The testing station 56 includes a printing module 85 with a spindle for mounting a roll 87 of paper tape and a plurality of guides 89 to guide paper from the roll 87 toward the print/test modules 80 as shown on FIG. 2. In one embodiment, the printing module 85 includes a motor (not shown) that operates a roller to push the paper under the testing station 56 so that an inkjet cartridge 70 placed in a print/test module 80 can print on the paper when the paper traverses under the inkjet cartridge 70. It is understood by one of ordinary skill in the art that while a spindle printing module 85 is shown, any other type of paper-based printing module may be used.

In a preferred embodiment, the user initiates the printing test 110 by touching the display interface 59. Paper from the roll 87 unwinds and traverses under the testing station 56 just below each of the print/test modules 80. Because the inkjet cartridge 70 is placed in a corresponding print/test module 80, the contacts 72 of the inkjet cartridge are electrically connected to the contacts 84 of the corresponding print/test module 80. Accordingly, the device 50 can instruct the inkjet cartridge to spray ink from the nozzles 74 on the paper. The paper will exit from the opposite end of the testing station 56 so that the user of the device 50 can tear off the paper and view the results of the printing test as performed by the cartridge 70.

In one preferred embodiment, the screen of the display interface 59 displays two print/test evaluation patterns to provide information to the user as to what constitutes an acceptable printout by the inkjet cartridge 70. The user is then able to validate independently the proper function of the print cartridge. Because each inkjet cartridge 70 may have different nozzle patterns, the device 50 displays on the display interface 59 a print/test evaluation that corresponds with the selected type and size of inkjet cartridge 70 being tested by the device 50. The print/test evaluation shows an unacceptable print pattern where a number of nozzles 74 are inoperative 111. For example, a unacceptable print pattern may show that more than six of the nozzles 74 do not spray ink onto the paper and several adjacent nozzles 74 may be inoperative. During the printing test, each nozzle 74 is used to print a line for a particular length on the paper. The display interface shows appropriately if one or more nozzles are inoperative.

One of ordinary skill in the art appreciates, however, that depending on the nozzle configuration and the numbers thereof, the number of inoperative nozzles from the inkjet cartridge 70 that may makes a print pattern acceptable or unacceptable may differ greatly depending on the configuration and the manufacturer of the inkjet cartridge 70.

In a preferred embodiment, if a printing test is determined to be unsuccessful by the user once the results of the test are compared 120 with the minimum acceptable standard 111, the user activates a button on the interface display 59. The user is then invited to either to wipe the nozzles 74 with a damp cloth and conduct a new printing test, to blot the inkjet cartridge on dry cloth to wick out ink, or to run the inkjet cartridge 70 through a special remedy cycle.

When the third option is selected by the user, the inkjet cartridge 70 must be replaced 115 in the corresponding filling module 90 so that a special remedy cycle 116 may be performed. In a preferred embodiment, the user is guided through the remedy cycle with the help of information displayed on the display interface 59. A vacuum meter, an pressure meter, or other such device can display information during the drainage of the ink 117 from the cartridge. Once the remedy cycle has ended 118, the user is instructed to perform a new printing test 109 as described herein. The remedy cycle 116 may be repeated if the electrical and/or printing test fails. If the inkjet cartridge passes the printing test at the conclusion of the remedy cycle once, the user is instructed to place a particular clip 120 and a sticker label 122 on the cartridge. Details regarding the clips 120 used for each cartridge and how a user can access the clips 120 and the sticker labels 122 and the functions of each of the noted components are described in detail below.

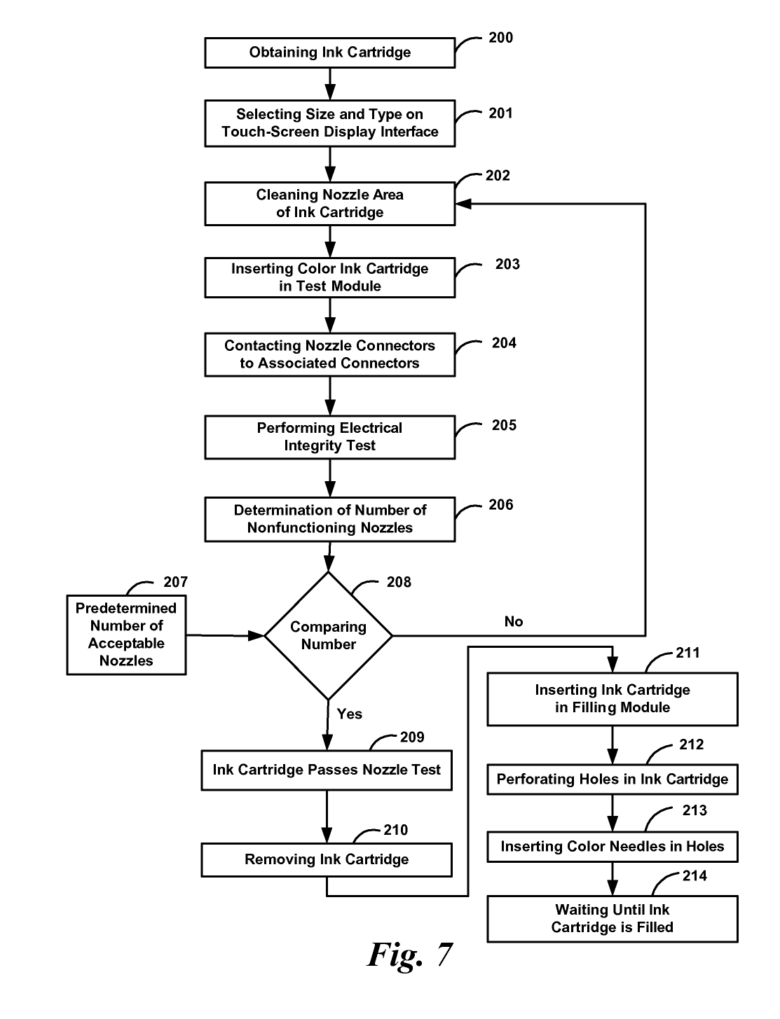

The steps of maintaining and refilling a color inkjet cartridge shown on FIG. 7 as 200 to 214 are similar in all respects to the steps of maintaining and refilling the black inkjet cartridge 70 except for the steps of evacuating, refilling, and conducting a printing test of the color inkjet cartridge 70. After electrically testing a color inkjet cartridge 70, the color inkjet cartridge 70 is placed in the corresponding refilling module 90. Color inkjet cartridges can be filled through vent holes disposed on top of the color inkjet cartridge 70. The device 50 includes a plurality of color filling needles 60 that are centrally located on the upper cabinet 52. In a preferred embodiment, the device 50 is shown to include three needles 60 with different colors, namely, yellow, magenta and cyan, intended to be inserted by perforating holes 212 in the color inkjet cartridge via the vent holes. It is understood by one of ordinary skill in the art that any possible arrangement of ink color can be used according to market demand.

To fill or evacuate a color inkjet cartridge 70, each needle can be pulled out of a holder 130 and inserted 213 into a corresponding vent hole of the color inkjet cartridge 70 associated with the color to be used. It is understood by one of ordinary skill in the art of cartridge refill that vent holes may be partly hidden by stickers or other physical objects to protect against the unwanted passage of air through the vent hole. A needle 60 punctures through any barrier and is inserted into the vent hole 212. The holder 130 includes a sensor (not shown) that detects whether the corresponding color fill needle 60 is inserted in its designated holder 130 or is missing. In a preferred embodiment, a safety measure is designed into the automated control system to alert the user if no needle is inserted into a cartridge and the filling or evacuation steps are requested. It is understood by one of ordinary skill in the art that numerous safety measures can be added at each step of the refilling process to guide the user. It is also understood that such safety measures are a tradeoff with the overall ease of use of the device 50 and that while some preferred steps and measures are disclosed, the automated control system may be optimized and customized based on observation of user manipulation of the device 50.

Using needles 60 inserted into the vent holes 76, the evacuating and refilling process as described herewith in relation to the black inkjet cartridge may be initiated. In one preferred embodiment, the display interface 59 shows color-coded displays of information during the refilling and evacuating operations. Once the color inkjet cartridge 70 is filled 214, the user is instructed to remove the color fill needles 60 from the color inkjet cartridge 70 and place each color fill needle 60 back in the correct holder 76. Again, because each holder 130 has a sensor to determine the presence of a color fill needle 60, the display interface 59 may alert the user to remove all color fill needles 60 from the color inkjet cartridge 70 should the user fail to remove the appropriate color fill needle 60.

The printing test of a color cartridge as shown on FIG. 8 is very similar to the printing test for a black inkjet cartridge except that the nozzles 74 for each color, i.e., yellow, magenta and cyan, may be alternatively or sequentially used to print a pattern on the paper. The method also includes the steps of inserting a color needle during the remedy cycle 223 and returning the color needle once the drainage has ended 226. It is understood by one of ordinary skill in the art of cartridge testing that a determination of the location of nonfunctioning nozzles in association with the resulting printout produced by the cartridge 70 is used to determine what constitutes an acceptable minimum number and location of functioning nozzles for each different type and size of color inkjet cartridge 70.

In one embodiment to place, if the color inkjet cartridge 70 passes the printing test, the user is instructed to remove the color inkjet cartridge 70 and place a clip 120 on the inkjet cartridge 70, or in another preferred embodiment, to attach a sticker 122 on the appropriate location on the inkjet cartridge 70 to cover vent holes 76 punctured by the fill needles 60 during the refilling operation. It is understood by one of ordinary skill in the art that when a inkjet cartridge 70 is filled using needles 60, the puncture holes on the cartridge 70 should be recovered to equalize the pressure in the color inkjet cartridge 70 with the outside pressure. The size of the vent holes 76 and how air is vented into the color inkjet cartridge 70 may be critical in producing acceptable printing results. For example, certain inkjet cartridges have various channels (not shown) on top thereof that are connected to the vent holes 76. These channels may extend beyond the sticker so that air can enter through these channels and reach the vent holes 76. Therefore, placing the sticker 122 on the inkjet cartridge 70 after refilling the inkjet cartridge 70 may be necessary. Furthermore, the nozzles 74 of the cartridge should remain moist or unexposed to air so that any ink that may be resting at the nozzles 74 does not coagulate and clog the nozzles 74. Therefore, the device 50 provides the number of clips 120, with each clip 120 configured for a particular color inkjet cartridge 70 from a particular manufacturer. When the clip 120 is placed on the color inkjet cartridge, it covers the nozzles 74 so as to not expose the nozzles 74 to air.

Referring to FIG. 4, clips 120 may be stored in the equipment storage cabinet 62 of the lower cabinet 54. Each clip 120 may be in a particular bin that is labeled for easy retrieval and indexing. In one preferred embodiment as shown in FIG. 4, the equipment storage cabinet 62 includes a plurality of bins 140 that are labeled with letters. It is understood by one of ordinary skill in the art that the display interface 59 may be used to guide the user in the selection and placement of the appropriate sticker 122 and clip 120 from the appropriate bin 140.

FIG. 11 is a block diagram of the automated control system of the device 50. The upper cabinet 52 and the lower cabinet 54 may also contain control electronics associated with the various electronic and mechanical components that provide the above-described operations of the device 50. The device 50 operates by an automated control system and is understood by one of ordinary skill in the design of automated control system to include a controller module 150, at least a processor 152, a memory 154, and a communication port or bus 182, 184, or 186. The automated control system is connected functionally to subcomponent of the device 50, such as the print/test modules 80, the refilling modules 90, the print/test module controllers 158, a printing module 110, a display interface 59, pumps 170 and 172, and other mechanical and electronic components 180. Each of the print/test module controllers 158 of the print/test modules 80 includes at least a processor 160, memory 162, and a communication port or bus 164 for communication with the main controller module 150. It is understood by one of ordinary skill in the art that while two pumps 170 and 172 are shown in FIG. 11, illustrating the refilling and the drainage functions, the use of ink pumping and transporting means may comprise peristaltic pumps, gravitational pumps, centrifugal pumps, air pressure vessels, hydraulic forces, or any other ink transportation means used in the field. It is also understood that while additional display information, such as the use of LEDs 82 and 92 associated with each print/test module 80 and refilling module 90, is not shown in FIG. 11, a plurality of additional user guidance methods can be implemented to facilitate the use of the device 50.

Each of the print/test module controllers 158 can control the operation of the corresponding printing/test module 80. In a contemplated embodiment, each print/test controller 158 may also include specific information about the inkjet cartridge 70 with which the print/test module 80 is compatible. For example, the memory 162 of each print/test module controller 158 may include information on how to operate, i.e., print, with a particular inkjet cartridge 70 from a particular manufacturer. The commands to actually print or test the particular cartridge 70, however, may be issued by the main controller 150. Subsequently, after receiving the commands from the main controller 150, each print/test module 158 may independently operate to print and test a corresponding inkjet cartridge 70.

The main controller 150 may also control the operations of the display interface 59. When a user touches a display interface 59 such as a touch-screen display to enter a command, that command is sent to the main controller 150, after which the processor 152 processes the information sent by the display and sends reply information, which may be a particular display screen, to the display interface 59. The device 50 may include one or more pumps that provide pumping of ink from the ink supply containers 55 to an inkjet cartridge 70. In the disclosed examples, the device 50 includes a pair of multichannel peristaltic pumps 170 and 172, which can provide simultaneous pumping of all colors into an inkjet cartridge 70. The peristaltic pumps 170 and 172 also provide precise metering of the correct amount of ink for each color of a color inkjet cartridge 70, or for the black ink refilling of a black inkjet cartridge 70. The device 50 may include other mechanical and electronic components 180 that are operatively coupled to the main controller 150.

The device 50 also may include a USB (Universal Serial Bus) communication port 182 that allows an operator of the device 50 to upgrade or maintain the software that is stored on the memory 154 of the main controller 150 or the memory 164 of each of the print/test module controllers 158, as necessary. Additionally, through the USB communication port 182, an operator can collect data from the device 50 that may be stored in the memory 152 regarding the operation of the device 50 over a certain period of time. Accordingly, the USB communication port 182 provides for maintenance, upgradeability, and modifications of any software that may be stored on memory 154 of the main controller 150, or on the individual memories 164 of each print/test module controller 158.

The device 50 may also include a serial port 184 from which the device 50 can operate a printer, another display, or other electronic accessories. For example, a printer can be connected to the serial port 184 so that after a user refills a cartridge, the printer that is connected to the serial port 184 can print a barcode label containing pricing information. Accordingly, the user can use the printed barcode label or pricing information to pay for the refilling of the inkjet cartridge 70 at a cashier station in the store in which the device 50 is installed.

The device 50 can also include the wireless communication port 186 that can provide wireless communication of the device 50 with other devices. For example, an operator of the device 50 or the manufacturer of the device 50 can remotely communicate with the device 50 through the wireless port 186 for diagnosing the various functions of the device 50, upgrading the software on the device 50, or simply maintaining the various functions of the device 50. The wireless communication port 186 may enable the manufacturer of the device 50 to remotely communicate with the device 50 from a different geographic location to continuously upgrade the device 50 and/or to collect data from the device 50. Furthermore, if more than one device 50 is installed in a location, two devices 50 can communicate with each other to exchange data. For example, if one device 50 is malfunctioning or has depleted one of its ink supplies, it can check with the other device 50 and provide a message on the display 59 to the user to use the other device 50 to perform the cartridge maintenance and refill operation. Accordingly, one of ordinary skill in the art appreciates the numerous operational configurations that can be provided with the wireless communication capability through the wireless port 186 of the device 50.

One of ordinary skill in the art appreciates that the diagram shown in FIG. 11 is only an example of how the various internal components of the device 50 operate and can communicate with each other to provide the functionality that is described in detail in the foregoing. Other configurations of the internal components of the device 50 are possible. For example, the main controller 150 may simply be a personal computer motherboard that includes various processors, memories, graphics cards, communication ports, etc. The display interface 59 could be a typical LCD display that is used in small, portable computers, car navigation displays, or the like. Furthermore, each of the print/test module controllers 158 can be a motherboard of a personal computer that may be modified for use in the device 50. Therefore, those of ordinary skill in the art appreciate that any electronic or mechanical component can be used in the device 50 to provide the functionality of the device 50 as described in detail in the foregoing.

What is claimed is:

1. An ink cartridge testing and refilling device, said device comprising:
a housing;
a cartridge testing station;
a cartridge refilling station;
an ink supply;
an automated control system; and
a display interface;
wherein the cartridge testing station, the cartridge refilling station and the display interface are mounted in said housing, the ink supply is connected to the cartridge refilling station by an ink pumping and transporting means, and the automated control system is located inside of the housing and is connected with a series of electronics control to the refilling station, the testing station, the ink pumping and transporting means, and the display interface.

2. The device of claim 1, wherein the testing station comprises a plurality of test modules able to test different sizes and types of ink cartridges.

3. The device of claim 1, wherein the refilling station is made of a plurality of refilling modules able to refill different printer cartridges.

4. The device of claim 1, wherein the housing further comprises a maintenance and cleaning station for ink cartridges.

5. The device of claim 1, wherein the housing further comprises an upper cabinet and a lower cabinet, and said lower cabinet further comprises an equipment storage cabinet.

6. The device of claim 5, wherein the lower cabinet further comprises a drawer.

7. The device of claim 6, wherein the ink supply is located in the drawer of the lower cabinet.

8. The device of claim 1, wherein the ink supply is black.

9. The device of claim 1, wherein the ink supply may be selected from the group consisting of cyan, magenta, yellow, and black for color ink cartridges.

10. The device of claim 8, wherein the ink supply also includes a container for waste ink.

11. The device of claim 9, wherein the ink supply also includes a container for waste ink.

12. The device of claim 1, wherein the interface comprises a touch-screen display that allows a user of the device to interface with the automated control system and be guided through the steps of operation of the device during testing and refilling of an ink cartridge.

13. The device of claim 1, wherein the automated control system includes a Universal Serial Bus (USB) communication port.

14. The device of claim 1, wherein the automated control system includes a serial port.

15. The device of claim 1, wherein the automated control system includes a wireless communication port.

16. The device of claim 1, wherein the ink pumping and transporting means comprises a multichannel peristaltic pump and tubes connecting said pump to said ink supply and said cartridge refilling station.

17. The method for testing and refilling a ink cartridge using an ink testing and filling station comprised of a housing, a cartridge testing station made of a plurality of testing modules equipped with a series of connectors, a cartridge refilling station made of a plurality of filling modules equipped with a series of connectors, an automated control system, a touch-screen display interface, and a paper printing device, wherein the cartridge test station, the cartridge refilling station, the paper printing device, and the display interface are mounted to the housing, and the automated control system is located inside of the housing and is connected via a series of control electronics to the refilling station, the testing station, and the display interface, the method comprising the steps of:
(a) obtaining an ink cartridge to be filled; the ink cartridge having a body, a head, and a nozzle area located on said body, the nozzle area having a series of nozzles each controlled by a connector;
(b) selecting on the touch-screen display interface a size and type associated with the ink cartridge obtained in step (a), said selection of the size and type on the touch-screen display interface activating a signal associated with one of the test modules of the test station by the automated control system;
(c) cleaning the nozzle area of the ink cartridge;
(d) inserting the ink cartridge in the testing module of step (b);
(e) initiating a testing sequence and repeating steps (c), (d), and (e) until the ink cartridge passes a nozzle test and a signal associated with a filling module of the filling station is activated;
(f) removing the ink cartridge from the testing module and inserting the ink cartridge in the filling module activated in step (e);
(g) waiting until the ink cartridge is filled to remove the ink cartridge from the filling module and cleaning excess ink from the nozzle area.

18. The method of claim 17 and further comprising the steps of (i) contacting the nozzle connectors to a series of associated connectors on the testing module, (ii) performing an electrical integrity test to confirm if each nozzle is functioning, (iii) determining a number of nonfunctioning nozzles, and (iv) comparing said number with a predetermined acceptable number by the automated control system to determine if the nozzle test is passed.

19. The method of claim 17 further comprising the steps of testing of the printing quality of the ink cartridge to determine if the ink cartridge is acceptable by placing the ink cartridge back into the test module as determined in step (b), performing a printing test using the paper printing device, and repeating steps (b) and (c) until the automated control system determines that printing quality is superior to a minimally acceptable standard.

20. The method of claim 19 further comprising the steps of initiating a remedy cycle if the automated control system is unable to determine that the printing quality exceeds a minimally acceptable standard, and conducting said nozzle test as defined in step (e), said remedy cycle comprising the steps of (i) removing the ink cartridge from the test module on the test station, (ii) returning the ink cartridge to the earlier defined appropriate filling module, (iii) initiating the remedy cycle by pushing the appropriate instruction on the touch-screen display, (iv) having the automated control system drain part of the ink from within the ink cartridge, (v) waiting until the ink cartridge is refilled to remove the ink cartridge from the filling module, and (vi) cleaning excess ink from the nozzle area of the ink cartridge.

21. The method of claim 17, wherein half of the ink is drained by the automated control system during the remedy cycle.

22. The method of claim 17, wherein the signal associated with a filling module and the signal associated with a test module is a blue LED.

23. The method of claim 17, wherein the signal associated with a filling module and the signal associated with a test module are graphic indicia displayed on the touch-screen display interface to be associated by the user with a number printed on the upper cabinet next to the testing module or the filling module.

24. The method of claim 17 further comprising the steps of placing a protective clip over the nozzle area of the black ink cartridge, and placing a new label sticker on the black ink cartridge.

25. The method of claim 18 further comprising the steps of placing a protective clip over the nozzle area of the black ink cartridge, and placing a new label sticker on the black ink cartridge.

26. The method of either claims 19 further comprising the steps of placing a protective clip over the nozzle area of the black ink cartridge, and placing a new label sticker on the black ink cartridge.

27. The method of either claims 20 further comprising the steps of placing a protective clip over the nozzle area of the black ink cartridge, and placing a new label sticker on the black ink cartridge.

28. A method for testing and refilling a color ink cartridge using a ink testing and filling station comprised of a housing, a cartridge testing station made of a plurality of testing modules, a cartridge refilling station made of a plurality of filling modules with designated drilling holes, an automated control system, a touch-screen display interface, a portable drill, a set of portable color needles, and a paper printing device, wherein the cartridge testing station, the cartridge refilling station, the paper printing device, the color needles, and the display interface are mounted to the housing, and the automated control system is located inside of the housing and is connected via a series of control electronics to the refilling station, the testing station, and the display interface, the method comprising the steps of:
(a) obtaining a color ink cartridge to be filled; the ink cartridge having a body, a head, and a nozzle area located on said body, the nozzle area having a series of nozzles each controlled by an electrical contact;
(b) selecting on the touch-screen display interface a size and type associated with the color ink cartridge obtained in step (a), said selection of the size and type on the touch-screen display interface resulting in the activation of a signal associated with one of the test modules of the test station by the automated control system;
(c) cleaning the nozzle area of the color ink cartridge;
(d) inserting the color ink cartridge in the test module of step (b);
(e) initiating a testing sequence and repeating steps (c), (d), and (e) until the color ink cartridge passes a nozzle test and a signal associated with a filling module of the filling station is activated;
(f) removing the color ink cartridge from the testing module;
(g) inserting the color ink cartridge in the filling module of step (e);
(h) perforating holes in the body of the color ink cartridge;
(i) inserting color needles into the holes; and
(j) waiting until the color ink cartridge is filled to remove the color needles from the body of the color ink cartridge, removing the color ink cartridge from the filling module, and cleaning excess ink from the nozzle area.

29. The method of claim 28 said nozzle test further comprising the steps of (i) contacting the nozzle connectors to a series of associated connectors on the test module, (ii) performing an electrical integrity test to confirm if each nozzle is functioning, (iii) determining a number of nonfunctioning nozzles, and (iv) comparing said number with a predetermined acceptable number by the automated control system to determine if the nozzle test is passed.

30. The method of claim 28 further comprising the steps of testing if the printing quality of the color ink cartridge is acceptable by placing the ink cartridge back into the test module as determined in step (b), performing a printing test using the paper printing device, and repeating steps (b) and (c) until the automated control system determines that printing quality is superior to a minimally acceptable standard.

31. The method of claim 29 further comprising the steps of:
initiating a remedy cycle if the automated control system is unable to determine that the print quality exceeds a minimally acceptable standard, and conducting a nozzle test as defined in step (e), said remedy cycle comprising the steps of (i) removing the color ink cartridge from the testing module on the testing station, (ii) returning the color ink cartridge to the earlier defined appropriate filling module, (iii) inserting the color needles into the color ink cartridge, (iv) initiating the remedy cycle by pushing the appropriate instruction on the touch-screen display, (v) having the automated control system drain part of the ink from within the ink cartridge, (vi) returning the color needles to the upper cabinet, waiting until the ink cartridge is filled to remove the color ink cartridge from the filling module, and (vii) cleaning excess ink from the nozzle area of the ink cartridge.

32. The method of claim 28, wherein half of the ink is drained by the automated control system during the remedy cycle.

33. The method of claim 28, wherein the signal associated with a filling module and the signal associated with a test module is a blue LED.

34. The method of claim 28, wherein the signal associated with a filling module and the signal associated with a testing module are numbers displayed on the touch-screen display interface to be associated by the user with a number printed on the upper cabinet next to testing module or the filling module.

35. The method of either claims 28, further comprising the steps of placing a protective clip over the nozzle area of the color ink cartridge, and placing a new label sticker on the color ink cartridge.

36. The method of either claims 29, further comprising the steps of placing a protective clip over the nozzle area of the color ink cartridge, and placing a new label sticker on the color ink cartridge.

37. The method of either claims 30, further comprising the steps of placing a protective clip over the nozzle area of the color ink cartridge, and placing a new label sticker on the color ink cartridge.

38. The method of either claims 31, further comprising the steps of placing a protective clip over the nozzle area of the color ink cartridge, and placing a new label sticker on the color ink cartridge.

39. An ink cartridge testing and refilling device, said device comprising:
an housing made of an upper cabinet and a lower cabinet;
a cartridge testing station;
a cartridge refilling station;
an ink supply;
an automated control system; and
a display interface;
wherein the cartridge testing station, the cartridge refilling station and the display interface are mounted in said housing to the upper cabinet, and the ink supply is located inside the lower cabinet and is connected to the cartridge refilling station by an ink pumping and transporting means, and the automated control system is located inside of the housing and is connected with a series of electronic controls to the refilling station, the testing station, the ink pumping and transporting means, and the display interface.

40. An ink cartridge testing device, said device comprising:
a housing;
a cartridge testing station;
an automated control system; and
a display interface;
wherein the cartridge testing station and the display interface are mounted in said housing, and the automated control system is located inside the housing and is connected with a series of electronic controls to the testing station, and the display interface; and
wherein the testing station further comprises at least a testing module with a testing interface comprising a series of connectors for performing an electrical integrity test on a cartridge equipped with associated nozzle connectors and for determining a number of nonfunctioning nozzles, and for comparing said number with a predetermined acceptable number by the automated control system to determine if a nozzle test is passed.

41. The device of claim 40, wherein the at least one testing module comprises a plurality of test modules able to test different sizes and types of ink cartridges.

42. The device of claim 40, wherein said display interface is separately but operatively connected to the housing by said series of electronic controls.

43. The device of claim 40, wherein the interface comprises a touch-screen display that allows a user of the device to interface with the automated control system and be guided through the steps of operation of the device during testing of an ink cartridge.

44. The device of claim 40, wherein the automated control system includes a Universal Serial Bus (USB) communication port.

45. The device of claim 40, wherein the automated control system includes a serial port.

46. The device of claim 40, wherein the automated control system includes a wireless communication port.

47. A method for testing an ink cartridge using a ink testing station device comprised of a housing, a cartridge testing station, an automated control system, a touch-screen display interface, wherein the cartridge testing station and the display interface are mounted to the housing, and the automated control system is located inside of the housing and is connected via a series of control electronics to the testing station, and the display interface, and wherein the testing station further comprises at least a testing module with a testing interface comprising a series of connectors to be associated with a series of associated nozzle connectors relating to nozzles on a cartridge to be inserted in the testing module, and for comparing said number with a predetermined acceptable number by the automated control system to determine if a nozzle test is passed, the method comprising the steps of: (a) contacting the connectors to a series of associated nozzle connectors on the test module, (ii) performing an electrical integrity test to confirm if each nozzle is functioning, (iii) determining a number of nonfunctioning nozzles, and (iv) comparing said number with a predetermined acceptable number by the automated control system to determine if the nozzle test is passed.

48. The method of claim 47, wherein said display interface is separately but operatively connected to the housing by said series of electronic controls.
